(19) United States
(12) Patent Application Publication
(10) Pub. No.: US 2017/0222715 A1
(43) Pub. Date: Aug. 3, 2017

(54) APPARATUS AND METHOD FOR LOCALIZING DEFECT LOCATION AND APPARATUS AND METHOD FOR IDENTIFYING CAUSE OF DEFECT IN OPTICAL TRANSPORT NETWORK (OTN) BASED ON TANDEM CONNECTION MONITORING (TCM) COORDINATES AND DEFECT TRACEBACK

(71) Applicant: ELECTRONICS AND TELECOMMUNICATIONS RESEARCH INSTITUTE, Daejeon (KR)

(72) Inventors: Won Kyoung LEE, Daejeon (KR); Ho Geon KIM, Daejeon (KR); Jeong-dong RYOO, Daejeon (KR); Taesik CHEUNG, Daejeon (KR); Bheom Soon JOO, Daejeon (KR)

(21) Appl. No.: 15/398,894

(22) Filed: Jan. 5, 2017

(30) Foreign Application Priority Data
Jan. 29, 2016 (KR) 10-2016-0011611

(51) Int. Cl. H04B 10/079; H04J 14/02

(52) U.S. Cl. CPC H04B 10/0791; H04J 14/0227; H04J 2203/0051

(57) ABSTRACT

A method of localizing a defect location and a method of identifying a cause of a defect in an optical transport network (OTN). The method of localizing a defect location in an OTN includes generating tandem connection monitoring (TCM) coordinates consisting of a TCM level and trail information of an optical data unit (ODU) based on a relationship between an OTN line card (LC) and the ODU in the OTN, localizing the defect location in the OTN by converting the TCM level to a segment on the TCM coordinates, and identifying a root cause using a defect identification algorithm that traces back the cause of the defect in an opposite direction to that in which the defect is propagated based on an OTN layer structure.

### CROSS-REFERENCE TO RELATED APPLICATION(S)

This application claims the priority benefit of Korean Patent Application No. 10-2016-0011611, filed on Jan. 29, 2016, in the Korean Intellectual Property Office, the disclosure of which is incorporated herein by reference for all purposes.

### BACKGROUND

1. Field

One or more example embodiments relate to a method of localizing a defect and a method of identifying a cause of a defect in an optical transport network (OTN) by tracing back the defect based on tandem connection monitoring (TCM) coordinates, and more particularly, to a method of localizing a defect location in an OTN based on TCM coordinates consisting of a TCM level and trail information of an optical data unit (ODU) and identifying a cause of the defect in the OTN by tracing back information on the defect occurring in the localized defect location in an opposite direction to that in which the defect is propagated based on OTN layer structure.

2. Description of Related Art

An optical transport network (OTN) may include and transmit all services, for example, a voice service, a data service, and a video service, and provide a synchronous digital hierarchy (SDH) having a high level of survivability.

An operations, administration and management (OAM) function for the OTN may use three independent monitoring overheads, for example, section monitoring (SM), path monitoring (PM), and tandem connection monitoring (TCM).

In particular, in an OTM layer structure in which a number of optical data units (ODUs) having relatively small volumes are multiplexed to an ODU having a relatively large volume, a defect may be propagated to a path layer from a section layer even when the defect has a single cause. Thus, it may be difficult to identify the root cause of such defect because there may be other defects as well.

Accordingly, the ability to localize a defect location in the OTN and analyze the root cause of the defect may be significant for OTN fault management.

Related technology for localizing a location of a defect in an OTN may include loopback technology and alarm suppression technology using an alarm indication signal (AIS). The related art using the loopback technology may have difficulty interrupting a service in the OTN while a loopback process is running. The alarm suppression technology using the AIS may be used to decrease a number of all alarms displayed through a network management system (NMS). Here, the alarm suppression technology using the AIS may only report an alarm that is generated on a relatively high layer having a large volume to the NMS, and may not report an alarm generated on a relatively low layer having a small volume by suppressing the alarm based on the AIS. However, when defects concurrently occur, due to another cause, on a layer lower than a layer on which the alarm is generated, the alarm suppression technology using the AIS may have difficulty because the alarm generated on the lower layer due to another cause is not reported until the alarm generated on the higher layer has been cleared.

Thus, the present disclosure may propose a method that quickly finds the root cause of the defect and a defect location in order to enhance defect management for the OTN and to solve the problem the related technology does not solve.

### SUMMARY

An aspect of the present invention provides a method of identifying a root cause of a defect and a defect location in an optical transport network (OTN) in a faster and more accurate manner by localizing a defect location in the OTN based on tandem connection monitoring (TCM) coordinates consisting of a TCM level and trail information of an optical data unit (ODU), and identifying the root cause of the defect in the OTN based on a defect identifying algorithm that traces back the cause of the defect occurring in the OTN in an opposite direction to that in which the defect is propagated based on an OTN layer structure based on information on the defect occurring in the localized defect location.

According to an aspect, there is provided a method of localizing a defect location in an optical transport network (OTN) including generating tandem connection monitoring (TCM) coordinates consisting of a TCM level and trail information of an optical data unit (ODU) based on a relationship between an OTN line card (LC) and the ODU in the OTN, and localizing the defect location in the OTN by converting the TCM level into a segment on the TCM coordinates.

First ODUs having relatively small volumes may be multiplexed to a second ODU having a relatively large volume in the OTN, and the generating of the TCM coordinates may include dividing the OTN based on at least one segment based on the OTN LC associated with the first ODUs and the second ODU, and determining the TCM level based on the segment.

The TCM level may be determined based on the segment with respect to each of the first ODUs and the second ODU.

The method of localizing a defect location may further include identifying a root cause of a defect occurring in the localized defect location in the OTN.

Information on the defect occurring in the defect location may include information on whether a trail signal fail (TSF) and a server signal fail (SSF) occur.

According to another aspect, there is provided a method of identifying a cause of a defect in an optical transport network (OTN) including verifying whether a trail signal fail (TSF) and a server signal fail (SSF) occur in a defect location in the OTN, the defect location being determined based on tandem connection monitoring (TCM) coordinates consisting of a TCM level and trail information of an optical data unit (ODU) based on a relationship between an OTN line card (LC) and the ODU in the OTN, and identifying a cause of a defect occurring in the OTN by applying information on whether the TSF and the SSF occur to a defect identification algorithm.

The defect identification algorithm may trace back the cause of the defect occurring in the OTN in an opposite direction to that in which the defect is propagated based on an OTN layer structure.

The verifying may include verifying whether the TSF and the SSF occur based on an order of first ODUs having relatively small volumes and a second ODU having a relatively large volume, and the identifying may include sequentially applying, to the defect identification algorithm, information on whether the TSF and the SSF occur based on the order of the first ODUs having the relatively small volumes and the second ODU having the relatively large volume.

According to still another aspect, there is provided an apparatus for localizing a defect location in an optical transport network (OTN) including a setter configured to generate tandem connection monitoring (TCM) coordinates indicated by a TCM level and trail information of an optical data unit (ODU) based on a relationship between an OTN line card (LC) and the ODU in the OTN, and a localizer configured to localize the defect location in the OTN by converting the TCM level to a segment on the TCM coordinates.

The setter may include a divider configured to divide the OTN based on at least one segment based on the OTN LC associated with first ODUs and a second ODU, and a determiner configured to determine the TCM level based on the segment.

The localizer may include an identifier configured to identify TCM coordinates of a location at which a defect occurs among TCM coordinates associated with a monitoring mode, and a verifier configured to localize the defect location in the OTN based on the TCM level and the trail information of the ODU corresponding to the TCM coordinates of the location at which the defect occurs.

The apparatus for localizing a defect location may further include a storage configured to store information on the defect occurring in the localized defect location in the OTN.

According to yet another aspect, there is provided an apparatus for identifying a defect location in an optical transport network (OTN) including a verifier configured to verify whether a trail signal fail (TSF) and a server signal fail (SSF) occur in a defect location in the OTN, the defect location being determined based on tandem connection monitoring (TCM) coordinates consisting of a TCM level and trail information of an optical data unit (ODU) based on a relationship between an OTN line card (LC) and the ODU in the OTN, and an identifier configured to identify a cause of a defect occurring in the OTN by applying information on whether the TSF and the SSF occur to a defect identification algorithm.

The verifier may be configured to verify whether the TSF and the SSF occur based on an order of first ODUs having relatively small volumes and a second ODU having a relatively large volume, and apply, to the defect identification algorithm, information on whether the TSF and the SSF occur based on the order of the first ODUs having the relatively small volumes and the second ODU having the relatively large volume.

The defect identification algorithm may trace back the cause of the defect occurring in the OTN in an opposite direction to that in which the defect is propagated.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration for localizing a defect location in an optical transport network (OTN) and identifying a cause of a defect by tracing back the cause of the defect in an opposite direction to that in which the defect is propagated based on an OTN layer structure based on information on the defect occurring in the localized defect location according to an example embodiment;

FIG. 2 is a diagram illustrating a method of setting tandem connection monitoring (TCM) coordinates for localizing a defect location in an optical transport network (OTN) according to an example embodiment;

FIGS. 3A and 3B are diagrams illustrating cases in which a defect location is localized by converting tandem connection monitoring (TCM) coordinates from a TCM level to a segment according to an example embodiment;

FIG. 4 is a diagram illustrating a direction in which a defect is propagated in an optical transport network (OTN) layer structure according to an example embodiment; and

FIG. 5 is a diagram illustrating a method of identifying a cause of a defect by tracing back the defect according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

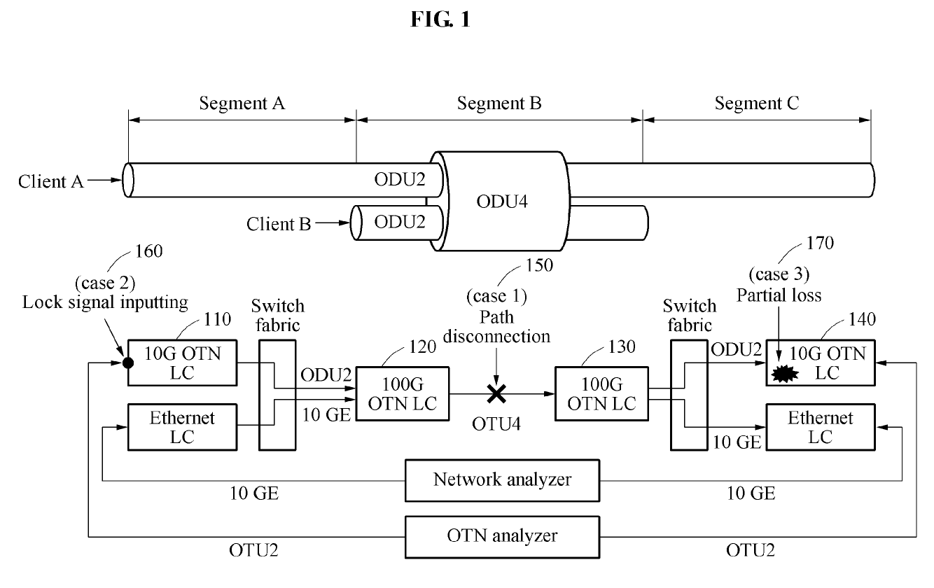

FIG. 1 is a diagram illustrating a configuration for localizing a defect location in an optical transport network (OTN) and identifying a cause of a defect by tracing back the cause of the defect in an opposite direction to that in which the defect is propagated based on an OTN layer structure based on information on the defect occurring in the localized defect location according to an example embodiment.

In an OTN, optical data units (ODUs) having relatively small volumes may be multiplexed to an ODU having a relatively large volume. As illustrated in FIG. 1, a plurality of ODU2s having relatively small volumes may be multiplexed to an ODU4 having the relatively large volume.

The ODU may perform a function of monitoring path connection and a function of connecting data between each end of terminals in the OTN. For example, as illustrated in FIG. 1, the ODU2 corresponding to a client A may be a data link that passes through two 10 G OTN line cards (LCs) and two 100 G OTN LCs existing in each of a segment A, a segment B, and a segment C. The data may be connected through the link, and the function of monitoring path connection may be performed for the segment A, the segment B, and the segment C included in the link corresponding to the respective ODU2s.

The ODU4 to which the ODU2 corresponding to the client A and the ODU2 corresponding to a client B are multiplexed may be a data link that passes through two 100 G OTN LCs existing in the segment B. The data may be connected through the link, and the function of monitoring path connection may be performed for the segment B included in the link corresponding to the ODU4.

The data connected through the link corresponding to the ODU may be transmitted through an optical transport unit (OTU) using at least one optical channel. For example, as illustrated in FIG. 1, the data connected through the link corresponding to the ODU2 corresponding to the client A may be transmitted through an OTU2 using at least one optical channel.

The data connected through the link corresponding to the ODU4 to which the ODU2 corresponding to the client A and the ODU2 corresponding to the client B are multiplexed may be transmitted through an OTU4 using at least one optical channel.

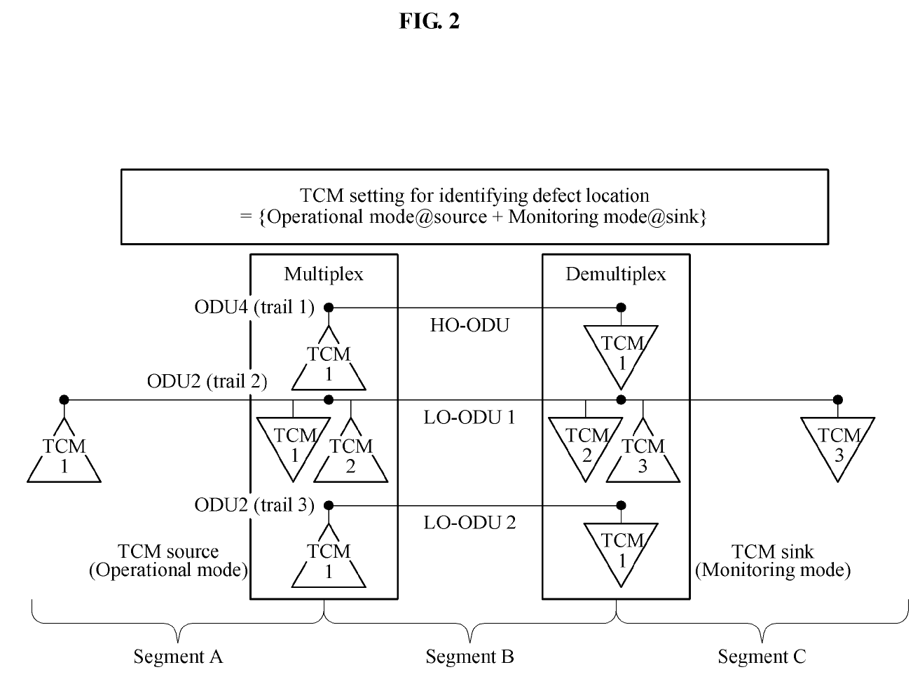

FIG. 2 is a diagram illustrating a method of setting tandem connection monitoring (TCM) coordinates for localizing a defect location in an optical transport network (OTN) according to an example embodiment.

The TCM coordinates may be used to localize a defect location in an OTN and identify a root cause of a defect occurring in the localized defect location in an accurate and fast manner.

An apparatus for localizing a defect location in an OTN, hereinafter, referred to as a defect location localizing apparatus, may set the TCM coordinates consisting of a TCM level and trail information of an optical data unit (ODU) based on a relationship between an OTN line card (LC) and the ODU.

For example, the defect location localizing apparatus divides the OTN based on at least one segment based on the OTN LC associated with a plurality of ODUs as illustrated in FIG. 1.

The data connected through the ODU2 corresponding to the client A may be transmitted through a switch fabric disposed between a 10 G OTN LC 110 and a 100 G OTN LC 120. In addition, the data connected through the ODU4 to which the ODU2 corresponding to the client A and the ODU2 corresponding to the client B are multiplexed may be transmitted between the 100 G OTN LC 120 and the 100 G OTN LC 130 through the OTU4 using at least one optical channel.

Thus, the data is actually transmitted through the OTN LC. Accordingly, the present disclosure may divide a segment based on the OTN LC included in the OTN.

The OTN is divided into the segment A from the 10 G OTN LC 110 to the 100 G OTN LC 120, the segment B from the 100 G OTN LC 120 to the 100 G OTN LC 130, and the segment C from the 100 G OTN LC 130 to a 10G OTN LC 140.

Subsequently, the defect location localizing apparatus may determine the TCM level using segments based on the OTN LC associated with a plurality of ODUs. Referring to FIG. 2, the ODU2 corresponding to the client A may include a monitoring segment from the segment A to the segment C. Here, the defect location localizing apparatus may determine the TCM level such that segments do not overlap each other. The segment A, the segment B, and the segment C included in the ODU2 corresponding to the client A may determine the TCM level as TCM 1, TCM 2, and TCM 3, respectively.

The ODU2 corresponding to the client B may include the monitoring segment in the segment B. Here, the defect location localizing apparatus may determine the TCM level as TCM 1 for the segment B.

Thus, the defect location localizing apparatus may set the TCM level for each segment for each of the ODUs, and the TCM level may be differently set for a same ODU.

The defect location localizing apparatus may classify the TCM coordinates such that the defect is not transferred from one TCM level to another TCM level. The defect location localizing apparatus may set, based on a data transmitting direction of the OTN, a TCM mode of a TCM source as the OPERATIONAL mode, and a TCM mode of a TCM sink as the MONITOR mode.

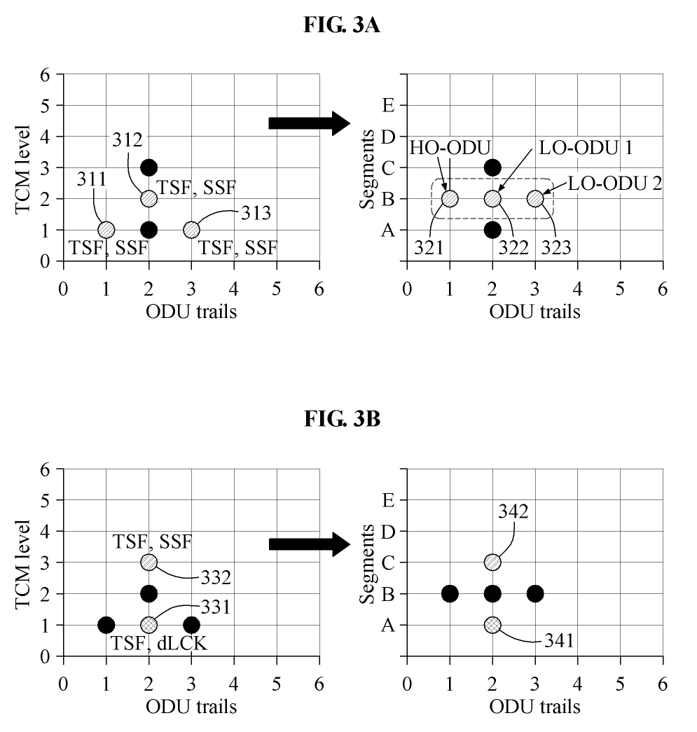

FIGS. 3A and 3B are diagrams illustrating cases in which a defect location is localized by converting tandem connection monitoring (TCM) coordinates from a TCM level to a segment according to an example embodiment.

The defect location localizing apparatus may localize the defect location in an OTN based on a TCM level allocated to each segment for each of the set ODUs illustrated in FIGS. 1 and 2.

The defect location localizing apparatus may identify a location at which a defect occurs on TCM coordinates.

For example, referring to a case 1 150 of FIG. 1, it is assumed that a loss of signal dLOS) is caused by disconnecting a link between the 100 G OTN LCs 120 and 130 included in the segment B. The defect location localizing apparatus may identify a segment in which the defect occurs with respect to each of ODUs on the TCM coordinates.

In the case 1 150, the defect location localizing apparatus may identify that the defect occurs at the TCM level allocated to the segment B of the ODU4 (corresponding to an ODU trail 1). The defect location localizing apparatus may identify that the defect occurs at the TCM level allocated to the segment B of the ODU2 (corresponding to an ODU trail 2) corresponding to the client A and the segment B of the ODU2 (corresponding to an ODU trail 3) corresponding to the client B.

The defect location localizing apparatus may identify the defect location in the OTN based on the TCM level and trail information of the ODU corresponding to the location at which the defect occurs.

As illustrated in a left graph of FIG. 3A, the TCM coordinates of the location at which the defect occurs may be represented in a graph of which a horizontal axis indicates an ODU trail and a vertical axis indicates the TCM level. The defect occurs at a TCM 1 311 in the ODU4 corresponding to the ODU trail 1, and the defect occurs at a TCM 2 312 in the ODU2 corresponding to the ODU trail 2. The defect occurs at a TCM 1 313 in the ODU2 corresponding to the ODU trail 3.

As illustrated in a right graph of FIG. 3A, the location at which the defect occurs in the OTN may be localized when the vertical axis is converted from the TCM level to a segment.

Referring to a case 2 160 of FIG. 1, a lock defect dLCLK may be caused by inputting a lock signal to the 10 G OTN LC 110 and a frame loss of frame defect dLOF may be caused due to a partial loss of an ODU2 frame in a fabric interface chip of the 10 G OTN LC 140. The defect location localizing apparatus may identify the TCM coordinates of the location at which the defect occurs in the segment with respect to each of the ODUs.

In the case 2 160, the defect location localizing apparatus may identify that the defect occurs at the TCM level allocated to the segment A and the segment C of the ODU2 (corresponding to the ODU trail 2) corresponding to the client A.

The defect location localizing apparatus may verify the defect location in the OTN based on the TCM level and the trail information of the ODU corresponding to the TCM coordinates of the location at which the defect occurs.

As illustrated in a left graph of FIG. 3A, the TCM coordinates of the location at which the defect occurs may be represented in the graph of which a horizontal axis indicates the ODU trail and a vertical axis indicates the TCM level. The defect occurs at each of a TCM 1 331 and a TCM 3 332 in the ODU2 corresponding to the ODU trail 2.

As illustrated in a right graph of FIG. 3B, the location at which the defect occurs in the OTN may be localized when the vertical axis is converted from the TCM level to the segment.

The defect location localizing apparatus may identify defect information in the location at which the defect occurs. The identified defect information may include information on whether a trail signal fail (TSF) and a server signal fail (S SF) occur.

Thus, it may be possible to easily identify the location at which the defect occurs even when a plurality of defects concurrently occurs in a plurality of ODUs based on the method of setting the TCM coordinates and the method of localizing the defect location in the OTN by converting the TCM coordinates from the TCM level to the segment.

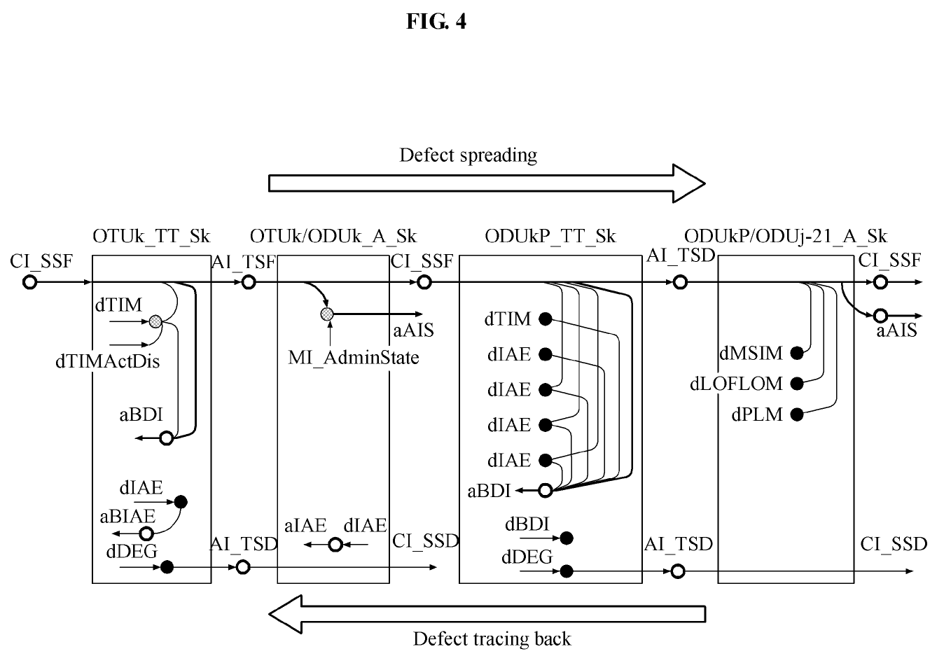

Detailed descriptions of the information on whether the TSF and the SSF occur will be provided with reference to FIG. 4.

FIG. 4 is a diagram illustrating a direction in which a defect is propagated in an optical transport network (OTN) layer structure according to an example embodiment.

In the OTN layer structure, a defect may be propagated from a section layer to a path layer. An OTU trail termination sink function OTUk_TT_Sk may be used to transmit defect information to an OTUk to ODUk adaptation sink function OTUk/ODUk_A_Sk in a form of a trail signal fail (TSF) consequent action, and to transmit the defect information to an opposite OTU trail termination source function through backward indication. The function OTUk_TT_Sk may be used to input an alarm indication signal (AIS) based on a signal fail state, and transmit the defect information to an ODUk pass trail termination sink function ODUkP_TT_Sk in a form of a server signal fail (SSF) consequent action.

Thus, a real cause of the defect may be identified by tracing back the cause of the defect in an opposite direction to that in which the defect is propagated in the OTN.

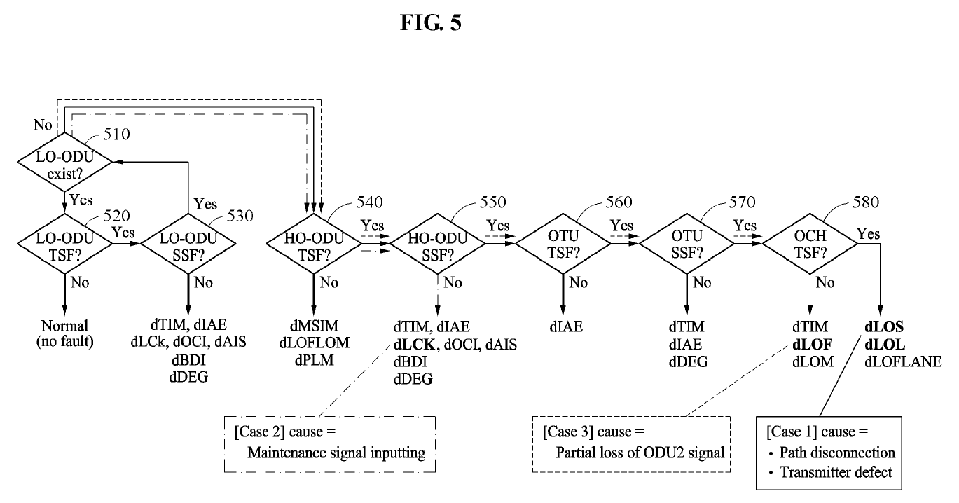

FIG. 5 is a diagram illustrating a method of identifying a cause of a defect by tracing back the defect according to an example embodiment.

As described above, an apparatus for identifying a cause of a defect, hereinafter referred to as a defect cause identification apparatus, may identify a basic cause of a defect by tracing back the cause of the defect in an opposite direction to that in which the defect is propagated.

The defect cause identifying apparatus verifies whether a trail signal fail (TSF) and a server signal fail (SSF) occur in a defect location in the OTN, and the defect location is determined based on tandem connection monitoring (TCM) coordinates consisting of a TCM level and trail information of an optical data unit (ODU) based on a relationship between an OTN line card (LC) and the ODU in the OTN.

The defect cause identifying apparatus verifies whether the TSF and the SSF occur based on an order of ODUs having relatively small volumes and an ODU having a relatively large volume.

The defect cause identifying apparatus identifies the cause of the defect occurring in the OTN by sequentially applying, to a defect identifying algorithm, information on whether the TSF and the SSF occur based on an order of first ODUs having relatively small volumes and a second ODU having a relatively large volume.

Referring to FIG. 5, the defect cause algorithm may be an algorithm that traces back the cause of the defect occurring in the OTN in an opposite direction to that in which the defect is propagated based on an OTN layer structure. The defect identifying algorithm may include the information on whether the TSF and the SSF occur in a location at which the defect occurs.

For example, referring to the case 1 150 of FIG. 1, it is assumed that a loss of signal (dLOS) is caused due to a path disconnection between two 100 G OTN LCs 120 and 130 included in the segment B. The defect cause identifying apparatus may identify whether the TSF and the SSF occur based on the order of the ODUs having the relatively small volumes and the ODU having the relatively large volume with respect to the segment B corresponding to the defect location verified by the defect location localizing apparatus.

When the loss of signal dLOS occurs as in the case 1 150, the TSF and the SSF may occur in the ODUs having the relatively small volumes, the ODU having the relatively large volume, and an optical transport unit (OTU). The TSF may also occur on an optical channel layer.

In operation 510, the defect cause identifying apparatus may verify whether the ODUs having the relatively small volumes exist in the segment B in which the defect occurs. Because the segment B has a structure in which the two ODUs having the relatively small volumes are multiplexed to the ODU having the relatively large volume, the ODUs having the relatively small volumes may exist in the segment B.

Thus, the defect cause identifying apparatus subsequently performs operations 520 and 530 along a solid line, and verifies whether the TSF and the SSF occur in the ODUs having the relatively small volumes.

Based on a result of the verifying that the TSF and the SSF occur in the ODUs having the relatively small volumes, the defect cause identifying apparatus subsequently performs operations 540 and 550 from operation 510 along the solid line and verifies whether the TSF and the SSF occur in the ODU having the relatively large volume.

Based on the result of the verifying that the TSF and the SSF occur in the ODU having the relatively large volume, the defect cause identifying apparatus subsequently performs operations 560 and 570 along the solid line and verifies whether the TSF and the SSF occur in the OTU.

Based on the result of the verifying that the TSF and the SSF occur in the OTU, the defect cause identifying apparatus subsequently performs operation 580 along the solid line and verifies whether the TSF occurs on the optical channel layer.

Based on the result of the verifying that the TSF occurs on the optical channel layer, the defect cause identifying apparatus identifies that the defect is caused because the loss of signal dLOS occurs as in the case 1 150.

Accordingly, the defect cause identifying apparatus identifies the cause of the defect by applying the defect identifying algorithm by tracing back the defect. Thus, the defect cause identifying apparatus identifies that the defect in the case 1 150 is the loss of signal dLOS caused by the path disconnection or a transmitter defect.

Causes of defects in the case 2 160 (a long dashed line) and the case 3 170 (a short dashed line) may be also identified by applying the defect identifying algorithm by tracing back the defects. Thus, the defect cause identifying apparatus identifies that the defect in the case 2 160 is a lock defect dLCK which is caused by inputting a maintenance signal, and the defect in the case 3 170 is a frame loss defect dLOF which is caused by an OTU clock being not properly recovered due to a partial loss of a frame of the ODU2.

A defect location localizing apparatus includes a setter configured to generate TCM coordinates consisting of a TCM level and trail information of an ODU based on a relationship between an OTN LC and the ODU in the OTN, and a localizer configured to localize the defect location in the OTN by converting the TCM level to a segment on the TCM coordinates.

The setter includes a divider configured to divide the OTN based on at least one segment based on the OTN LC associated with the first ODUs and the second ODU, and a determiner configured to determine the TCM level based on the segment.

The localizer includes an identifier configured to identify TCM coordinates of a location at which a defect occurs among TCM coordinates associated with a monitoring mode and a verifier configured to localize the defect location in the OTN based on the TCM level and the trail information of the ODU corresponding to the TCM coordinates of the location at which the defect occurs.

The defect location localizing apparatus further includes a storage configured to store information on the defect occurring in the localized defect location in the OTN. The information on the defect stored in the storage may be subsequently used to identify a root cause of the defect by the defect cause identifying apparatus.

The defect cause identifying apparatus includes the verifier configured to verify whether the TSF and the SSF occur in the defect location in the OTN, and the defect location is determined based on the TCM coordinates indicated by the TCM level and the trail information of the ODU based on the relationship between an OTN LC and the ODU in the OTN, and an identifier configured to identify the cause of the defect occurring in the OTN by applying information on whether the TSF and the SSF occur to the defect identifying algorithm.

The verifier is configured to verify whether the TSF and the SSF occur based on the order of the first ODUs having the relatively small volumes and the second ODU having the relatively large volume, and the identifier is configured to sequentially apply, to the defect identifying algorithm, information on whether the TSF and the SSF occur based on the order of the first ODUs having the relatively small volumes and the second ODU having the relatively large volume.

According to an aspect of the present invention, it is possible to identify a basic cause of a defect and a defect location in an OTN in a faster and more accurate manner by localizing a defect location in the OTN based on TCM coordinates consisting of a TCM level and trail information of an ODU, and identifying the cause of the defect in the OTN based on a defect identifying algorithm that traces back the cause of the defect occurring in the OTN in an opposite direction to that in which the defect is propagated based on an OTN layer structure based on information on the defect occurring in the localized defect location.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of localizing a defect location in an optical transport network (OTN), the method comprising:
generating tandem connection monitoring (TCM) coordinates consisting of a TCM level and trail information of an optical data unit (ODU) based on a relationship between an OTN line card (LC) and the ODU in the OTN; and
localizing the defect location in the OTN by converting the TCM level to a segment on the TCM coordinates.

2. The method of claim 1, wherein first ODUs having relatively small volumes are multiplexed to a second ODU having a relatively large volume in the OTN, and the generating of the TCM coordinates comprises dividing the OTN based on at least one segment based on the OTN LC associated with the first ODUs and the second ODU, and determining the TCM level based on the segment.

3. The method of claim 1, wherein the TCM level is determined based on the segment with respect to each of the first ODUs and the second ODU.

4. The method of claim 1, wherein the TCM modes of source and sink according to a TCM are configured as the OPERATIONAL mode and the MONITOR mode based on a data transmitting direction of the OTN, and the localizing comprises identifying TCM coordinates of a location at which a defect occurs among the TCM coordinates associated with the monitoring mode, and localizing the defect location in the OTN based on the TCM level and the trail information of the ODU corresponding to the TCM coordinates of the location at which the defect occurs.

5. The method of claim 1, further comprising:
identifying a root cause of a defect occurring in the localized defect location in the OTN.

6. The method of claim 5, wherein information on the defect occurring in the defect location includes information on whether a trail signal fail (TSF) and a server signal fail (SSF) occur.

7. A method of identifying a cause of a defect in an optical transport network (OTN), the method comprising:
verifying whether a trail signal fail (TSF) and a server signal fail (SSF) occur in a defect location in the OTN, the defect location being determined based on tandem connection monitoring (TCM) coordinates consisting of a TCM level and trail information of an optical data unit (ODU) based on a relationship between an OTN line card (LC) and the ODU in the OTN; and
identifying a cause of a defect occurring in the OTN by applying information on whether the TSF and the SSF occur to a defect identification algorithm.

8. The method of claim 7, wherein the defect identification algorithm traces back the cause of the defect occurring in the OTN in an opposite direction to that in which the defect is spread based on an OTN layer structure.

9. The method of claim 7, wherein the verifying comprises verifying whether the TSF and the SSF occur based on an order of first ODUs having relatively small volumes and a second ODU having a relatively large volume, and the identifying comprises sequentially applying, to the defect identification algorithm, information on whether the TSF and the SSF occur based on the order of the first ODUs having the relatively small volumes and the second ODU having the relatively large volume.

10. An apparatus for localizing a defect location in an optical transport network (OTN), the apparatus comprising:
a setter configured to generate tandem connection monitoring (TCM) coordinates consisting of a TCM level and trail information of an optical data unit (ODU) based on a relationship between an OTN line card (LC) and the ODU in the OTN; and
a localizer configured to localize the defect location in the OTN by converting the TCM level to a segment on the TCM coordinates.

11. The apparatus of claim 10, wherein the setter comprises:
a divider configured to divide the OTN based on at least one segment based on the OTN LC associated with first ODUs and a second ODU; and
a determiner configured to determine the TCM level based on the segment.

12. The apparatus of claim 10, wherein the localizer comprises:
an identifier configured to identify TCM coordinates of a location at which a defect occurs among TCM coordinates associated with a monitoring mode; and
a verifier configured to localize the defect location in the OTN based on the TCM level and the trail information of the ODU corresponding to the TCM coordinates of the location at which the defect occurs.

13. The apparatus of claim 10, further comprising:
a storage configured to store information on the defect occurring in the localized defect location in the OTN.
